(19) United States
(12) Patent Application Publication
(10) Pub. No.: US 2010/0270802 A1
(43) Pub. Date: Oct. 28, 2010

(54) WIND TURBINE

(75) Inventors: Walter M. Presz, JR., Wilbraham, MA (US); Michael J. Werle, West Hartford, CT (US)

Correspondence Address: FAY SHARPE LLP, 1228 Euclid Avenue, 5th Floor, The Halle Building, Cleveland, OH, 44115, US

(73) Assignee: FLODESIGN WIND TURBINE CORPORATION, Wilbraham, MA (US)

(21) Appl. No.: 12/749,341

(22) Filed: Mar. 29, 2010

Related U.S. Application Data
(63) Continuation-in-part of application No. 12/054,050, filed on Mar. 24, 2008.
Application No. 12/054,050 is a continuation-in-part of application No. 12/425,358, filed on Apr. 16, 2009.
Application No. 12/425,358 is a continuation-in-part of application No. 12/053,695, filed on Mar. 24, 2008.
Application No. 12/053,695 is a continuation-in-part of application No. 12/629,714, filed on Dec. 2, 2009.
(60) Provisional application No. 60/919,588, filed on Mar. 23, 2007.
(60) Provisional application No. 60/919,588, filed on Mar. 23, 2007.
(60) Provisional application No. 61/124,397, filed on Apr. 16, 2008.
(60) Provisional application No. 61/119,078, filed on Dec. 2, 2008.

(51) Int. Cl. F03D 9/00; F03D 1/04; F03D 1/06

(52) U.S. Cl. 290/52; 415/208.1; 290/55

(57) ABSTRACT

A wind turbine comprises an impeller and a turbine shroud disposed about the impeller. The impeller surrounds a center body having a central passageway through which air can flow through the center body to bypass the impeller. The impeller comprises a central ring and a plurality of impeller blades extending therefrom. When air passes through the impeller blades, some of its energy is used to turn the blades. The reduced-energy air is then mixed with the air flowing through the central passageway. This mixing allows the operating efficiency of the turbines to routinely exceed the Betz limit.

This application is a continuation-in-part of U.S. patent application Ser. No. 12/054,050, filed Mar. 24, 2008, which claimed priority to U.S. Provisional Patent Application Ser. No. 60/919,588, filed Mar. 23, 2007. This application is also a continuation-in-part of U.S. patent application Ser. No. 12/425,358, filed Apr. 16, 2009, which is a continuation-in-part of U.S. patent application Ser. No. 12/053,695, filed Mar. 24, 2008, which claimed priority to U.S. Provisional Patent Application Ser. No. 60/919,588, filed Mar. 23, 2007. U.S. patent application Ser. No. 12/425,358 also claimed priority to U.S. Provisional Patent Application Ser. No. 61/124,397, filed Apr. 16, 2008. This application is also a continuation-in-part of U.S. patent application Ser. No. 12/629,714, filed Dec. 2, 2009, which claimed priority to U.S. Provisional Patent Application Ser. No. 61/119,078, filed Dec. 2, 2008. The disclosure of these applications is fully incorporated by reference herein.

### BACKGROUND

This present disclosure relates to wind turbines, such as axial flow wind turbines. In particular, the wind turbines include a rotor or impeller that surrounds a center body having an open central passageway (i.e. central aperture). The central passageway allows air to flow through the center body and bypass the rotor or impeller. This air is later mixed with other air streams to improve the efficiency of the wind turbine/power generator.

In this regard, wind turbines usually contain a propeller-like device, termed the “rotor” or “impeller”, which is faced into a moving air stream. As the air hits the impeller, the air produces a force on the impeller in such a manner as to cause the impeller to rotate about its center. The impeller is connected to either an electricity generator or mechanical device through linkages such as gears, belts, chains or other means. Such turbines are used for generating electricity and powering batteries. They are also used to drive rotating pumps and/or moving machine parts. It is common to find wind turbines in large electricity generating “wind farms” containing multiple such turbines in a geometric pattern designed to allow maximum power extraction with minimal impact of each such turbine on one another and/or the surrounding environment.

The ability of an impeller to convert fluid power to rotating power, when placed in a stream of very large width compared to its diameter, is limited by the well documented theoretical value of 59.3% of the oncoming stream's power, known as the “Betz” limit as documented by A. Betz in 1926. This productivity limit applies especially to the traditional multi-bladed axial wind/water turbine presented in FIG. 1A, labeled Prior Art.

Existing wind turbines share a litany of troublesome limitations. These limitations include poor performance at low wind speed, which is relevant because many of the “good-wind” sites have been taken up and the industry has had to begin focusing on technologies for “small wind” sites. Also, safety concerns exist due to poor containment for damaged propellers and shielding of rotating parts. In addition, an irritating pulsating noise caused by the turbine can travel far from the source, disturbing others located long distances away. Moreover, significant bird strikes and kills occur, so that wildlife concerns are implicated. Furthermore, high first and recurring costs occur due to expensive internal gearing and expensive turbine blade replacements caused by high wind and wind gusts. Additionally, existing turbines have poor and/or unacceptable esthetics for urban and suburban settings. Finally, poor mixing of the air that passes through the impeller blades with higher energy air that does not pass through the impeller blades leads to inefficiencies.

Attempts have been made to try to increase wind turbine performance potential beyond the “Betz” limit. Shrouds or ducts surrounding the impeller have been used. See, e.g., U.S. Pat. No. 7,218,011 to Hiel et al. (see FIG. 1B); U.S. Pat. No. 4,204,799 to de Geus (see FIG. 1C); U.S. Pat. No. 4,075,500 to Oman et al. (see FIG. 1D); and U.S. Pat. No. 6,887,031 to Tocher. Properly designed shrouds cause the oncoming flow to speed up as it is concentrated into the center of the duct. In general, for a properly designed impeller, this increased flow speed causes more force on the impeller and subsequently higher levels of power extraction. Often though, the impeller blades break apart due to the shear and tensile forces involved with higher winds.

Values two times the Betz limit allegedly have been recorded but not sustained. See Igar, O., Shrouds for Aerogenerators, AIAA Journal, October 1976, pp. 1481-83; Igar & Ozer, Research and Development for Shrouded Wind Turbines, Energy Cons. & Management, Vol. 21, pp. 13-48, 1981; and see the AIAA Technical Note, entitled “Ducted Wind/Water Turbines and Propellers Revisited”, authored by Applicants (“Applicants' AIAA Technical Note”), and accepted for publication. Copies can be found in Applicants' Information Disclosure Statement. Such claims however have not been sustained in practice and existing test results have not confirmed the feasibility of such gains in real wind turbine application.

To achieve such increased power and efficiency, it is necessary to closely coordinate the aerodynamic designs of the shroud and impeller with the sometimes highly variable incoming fluid stream velocity levels. Such aerodynamic design considerations also play a significant role on the subsequent impact of flow turbines on their surroundings, and the productivity level of wind farm designs.

In an attempt to advance the state of the art, ducted (also known as shrouded) concepts have long been pursued. These have consistently provided tantalizing evidence that they may offer significant benefits over those of traditional unducted design. However, as yet, none have been successful enough to have significantly entered the marketplace. This is apparently due to several major weaknesses of current designs including: (a) they generally employ propeller based aerodynamic concepts versus turbine aerodynamic concepts, (b) they do not employ concepts for noise and flow improvements, and (c) they lack a first principles based ducted wind/water turbine design methodology equivalent to the “Betz/Schmitz Theory” that has been used extensively for unducted configurations.

Ejectors are known and documented fluid jet pumps that draw flow into a system and thereby increase the flow rate through that system. Mixer/ejectors are short compact versions of such jet pumps that are relatively insensitive to incoming flow conditions and have been used extensively in high speed jet propulsion applications involving flow velocities near or above the speed of sound. See, for example, U.S. Pat. No. 5,761,900 by Dr. Walter M. Presz, Jr, which also uses a mixer downstream to increase thrust while reducing noise from the discharge. Dr. Presz is a co-inventor in the present application.

Gas turbine technology has yet to be applied successfully to axial flow wind turbines. There are multiple reasons for this shortcoming. Existing wind turbines use non-shrouded turbine blades to extract the wind energy. As a result, a significant amount of the flow approaching the wind turbine blades flows around and not through the blades. Also, the air velocity decreases significantly as it approaches existing wind turbines. Both of these effects result in low flow through, turbine velocities. These low velocities minimize the potential benefits of gas turbine technology such as stator/impeller concepts. Previous shrouded wind turbine approaches have keyed on exit diffusers to increase turbine blade velocities. Diffusers, which typically include a pipe-like structure with openings along the axial length to allow slow, diffusive mixing of water inside the pipe with that outside the pipe, generally require long lengths for good performance. Diffusers also tend to be very sensitive to oncoming flow variations. Such long, flow sensitive diffusers are not practical in wind turbine installations. Short diffusers stall thus reducing the energy conversion of the system. Also, the downstream diffusion needed may not be possible with the turbine energy extraction desired at the accelerated velocities. These effects have hampered previous attempts at more efficient wind turbines using gas turbine technology.

Accordingly, it is an object of the present disclosure to provide an axial flow wind turbine that employs advanced fluid dynamic mixer/ejector pump principles to consistently deliver levels of power well above the Betz limit.

It is another object to provide an improved axial flow wind turbine that employs unique flow mixing (for wind turbines) of low energy air and high energy air and control devices to increase productivity of and minimize the impact of its attendant flow field on the surrounding environment located in its near vicinity, such as found in wind farms.

It is another object to provide an improved axial flow wind turbine that pumps in more flow through the impeller and then rapidly mixes the low energy turbine exit flow with high energy bypass wind flow before exiting the system.

It is a more specific object, commensurate with the above-listed objects, to provide an axial flow wind turbine which is relatively quiet and safer to use in populated areas.

### BRIEF DESCRIPTION

A mixer/ejector wind turbine system (referred to herein as the “MEWT”) for generating power is disclosed that combines fluid dynamic ejector concepts, advanced flow mixing and control devices, and an adjustable power turbine.

Disclosed in some embodiments is a wind turbine comprising a center body, an impeller, and a turbine shroud. The center body comprises a central passageway. The impeller is disposed about the center body and comprises a plurality of impeller blades. The turbine shroud is disposed about the impeller. The central passageway permits air to flow from one end of the turbine shroud to the other end without passing through the impeller.

The turbine shroud may be in the shape of a ring airfoil. Alternatively, the turbine shroud has a plurality of mixer lobes disposed around an exhaust end. Each mixer lobe on the turbine shroud has an inner trailing edge angle and an outer trailing edge angle, and the inner angle and the outer angle are independently in the range of 5 to 65 degrees.

The center body may also further comprise a plurality of mixer lobes disposed around an outlet end. Each mixer lobe on the center body has an inner trailing edge angle and an outer trailing edge angle, and the inner angle and the outer angle are independently in the range of 5 to 65 degrees.

The wind turbine may further comprise an ejector shroud downstream from and coaxial with the mixer shroud. A mixer shroud outlet extends into an ejector shroud inlet.

The ejector shroud may be in the shape of a ring airfoil. Alternatively, the ejector shroud has a ring of mixer lobes around an ejector shroud outlet. Each mixer lobe on the ejector shroud has an inner trailing edge angle and an outer trailing edge angle, and the inner angle and the outer angle are independently in the range of 5 to 65 degrees.

The impeller can be a rotor/stator assembly, the rotor/stator assembly including a rotor and a stator. The stator has at least one phase winding. The rotor has a central ring, an outer ring, a plurality of rotor blades extending between the central ring and the outer ring, and a plurality of permanent magnets on the outer ring. In some embodiments, the plurality of permanent magnets is located along a rear end of the outer ring. Alternatively, the wind turbine may further comprise a power generator located in the center body and connected to the impeller.

The wind turbine may further comprise a wing-tab or directional vane for aligning the wind turbine with the direction of airflow. The turbine shroud may have a non-circular frontal cross-section. An inlet area of the turbine shroud can be greater than an exit area of the turbine shroud.

Disclosed in other embodiments is a wind turbine comprising a center body, a rotor assembly, and a stator assembly. The center body comprises a central passageway. The rotor assembly rotates around the center body. The turbine shroud surrounds the rotor assembly. The stator assembly is upstream of the rotor assembly and connects the turbine shroud with the center body. The central passageway comprises a plurality of mixer lobes disposed around an outlet end thereof.

First-principles-based theoretical analysis of the preferred MEWT indicates that the MEWT can produce three or more times the power of its un-shrouded counterparts for the same frontal area, and increase the productivity of wind farms by a factor of two or more.

Other objects and advantages of the current disclosure will become more readily apparent when the following written description is read in conjunction with the accompanying drawings.

### BRIEF DESCRIPTION OF THE DRAWINGS

The following is a brief description of the drawings, which are presented for the purposes of illustrating the disclosure set forth herein and not for the purposes of limiting the same.

FIGS. 1A, 1B, 1C and 1D, labeled “Prior Art”, illustrate examples of conventional and prior turbines.

FIG. 2 is an exploded view of the components of an exemplary wind turbine of the present disclosure.

FIG. 3 is a front perspective view of an exemplary wind turbine attached to a support tower.

FIG. 4 is a front perspective view of a further exemplary embodiment of a wind turbine of the present disclosure.

FIG. 5 is a rear cross-sectional perspective view of an additional exemplary embodiment of a wind turbine of the present disclosure.

FIG. 6 is a front view of an exemplary wind turbine having wing-tabs or directional vanes for wind alignment.

FIG. 7A is a front perspective view of another exemplary embodiment of a wind turbine having a turbine shroud and an ejector shroud. The turbine shroud includes mixer lobes, while the ejector shroud has a ring airfoil shape.

FIG. 7B is a partial front cross-sectional view of the turbine of FIG. 7A with the ejector shroud removed, showing the mixer lobes on the turbine shroud.

FIG. 7C is a partial rear cross-sectional view of the turbine of FIG. 7A with the ejector shroud removed, showing the mixer lobes on the turbine shroud. The central passageway does not include mixer lobes.

FIG. 7D is a full cross-sectional view of the turbine of FIG. 7A.

FIG. 8A is a full rear cross-sectional view of a further exemplary embodiment of a wind turbine having a turbine shroud and an ejector shroud. The turbine shroud includes mixer lobes, while the ejector shroud has a ring airfoil shape. The central passageway also includes mixer lobes.

FIG. 8B is a full front cross-sectional view of the turbine of FIG. 8A.

FIG. 9A is a full rear cross-sectional view of an additional exemplary embodiment of a wind turbine having a turbine shroud and an ejector shroud. The turbine shroud, ejector shroud, and central passageway each include mixer lobes.

FIG. 9B is a full front cross-sectional view of the turbine of FIG. 9A.

FIG. 10 is a front perspective view of yet another exemplary embodiment of a MEWT having a central passageway.

FIG. 11 is a side cross-sectional view of the MEWT of FIG. 10.

FIGS. 12A and 12B are magnified views of the mixing lobes of the MEWT of FIG. 11.

FIGS. 13A and 13B are a magnified side view of a wind turbine and illustrate the use of flow blockage doors and a rotatable stator vane to control the flow of fluid through the turbine.

FIG. 14 is a cutaway view of another exemplary embodiment of a MEWT having a central passageway showing the stator portion of a ring generator.

FIG. 15 is a cutaway view of another exemplary embodiment of a MEWT having a central passageway showing the rotor portion of a ring generator.

FIG. 16 is a closeup view showing the rotor and stator of a ring generator in relation to each other.

FIG. 17 is the front view of an exemplary rotor.

FIG. 18 is the side view of an exemplary rotor.

FIG. 19 is the front view of an exemplary stator.

FIG. 20 is the side view of an exemplary stator.

FIG. 21 is a diagram illustrating the flow of faster air through the central passageway of a center body having mixer lobes.

FIG. 22 is a diagram illustrating the flow of slower air around the center body having mixer lobes. The slower air is formed by removing energy from fast air through the impeller.

FIG. 23 is a diagram illustrating the meeting of a faster air stream and a slower air stream.

FIG. 24 is a diagram illustrating a vortex formed by the meeting of a faster air stream and a slower air stream.

FIG. 25 is a diagram illustrating the resulting series of vortices formed by the mixer lobes on the center body.

FIG. 26 is a cross-sectional diagram of a center body having mixer lobes.

### DETAILED DESCRIPTION

A more complete understanding of the components, processes, and apparatuses disclosed herein can be obtained by reference to the accompanying figures. These figures are merely schematic representations based on convenience and the ease of demonstrating the present development and are, therefore, not intended to indicate the relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also disclosed the range “from 2 to 4.”

A wind turbine can theoretically capture at most 59.3% of the potential energy of the wind passing through it, a maximum known as the Betz limit. The amount of energy captured by a wind turbine can also be referred to as the efficiency of the turbine. The MEWT may exceed the Betz limit.

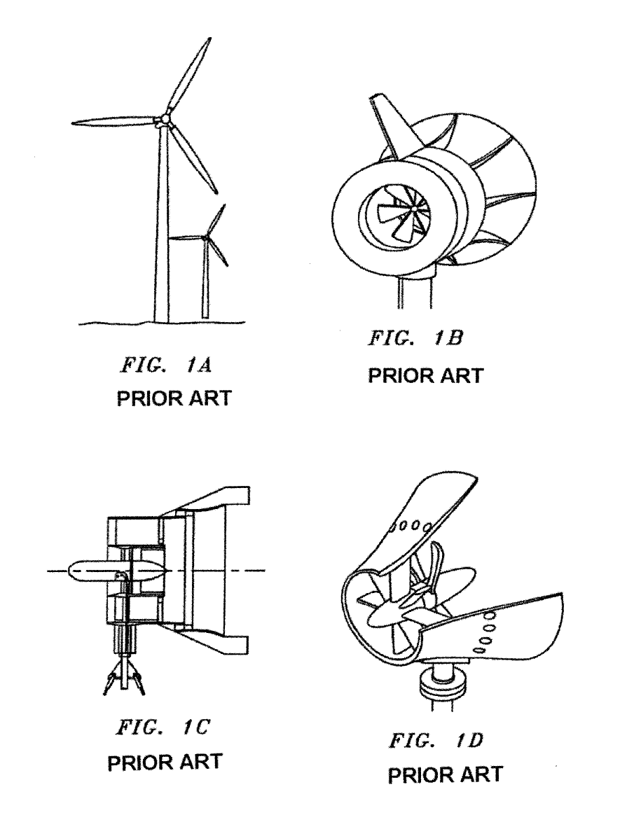

FIG. 1A-1D show prior art wind turbines. Such turbines are limited by the Betz limit.

A Mixer-Ejector Power System (MEPS) provides a unique and improved means of generating power from wind currents. A MEPS includes:
a primary duct containing a turbine or propeller blade which extracts power from the primary stream; and
a single or multiple-stage mixer-ejector to ingest flow with each such mixer/ejector stage including a mixing duct for both bringing in secondary flow and providing flow mixing-length for the ejector stage. The mixing duct inlet contours are designed to minimize flow losses while providing the pressure forces necessary for good ejector performance.

The resulting mixer/ejectors enhances the operational characteristics of the power system by: (a) increasing the amount of flow through the system, (b) reducing the back pressure on the turbine blade, and (c) reducing the noise propagating from the system.

The MEPS may include:
camber to the duct profiles to enhance the amount of flow into and through the system;
acoustical treatment in the primary and mixing ducts for noise abatement flow guide vanes in the primary duct for control of flow swirl and/or mixer-lobes tailored to diminish flow swirl effects;
turbine-like blade aerodynamics designs based on the new theoretical power limits to develop families of short, structurally robust configurations which may have multiple and/or counter-rotating rows of blades;
exit diffusers or nozzles on the mixing duct to further improve performance of the overall system;
inlet and outlet areas that are non-circular in cross section to accommodate installation limitations;
a swivel joint on its lower outer surface for mounting on a vertical stand/pylon allowing for turning the system into the wind current;
vertical aerodynamic stabilizer vanes or directional vanes mounted on the exterior of the ducts with tabs to keep the system pointed into the wind; or
mixer lobes on a single stage of a multi-stage ejector system.

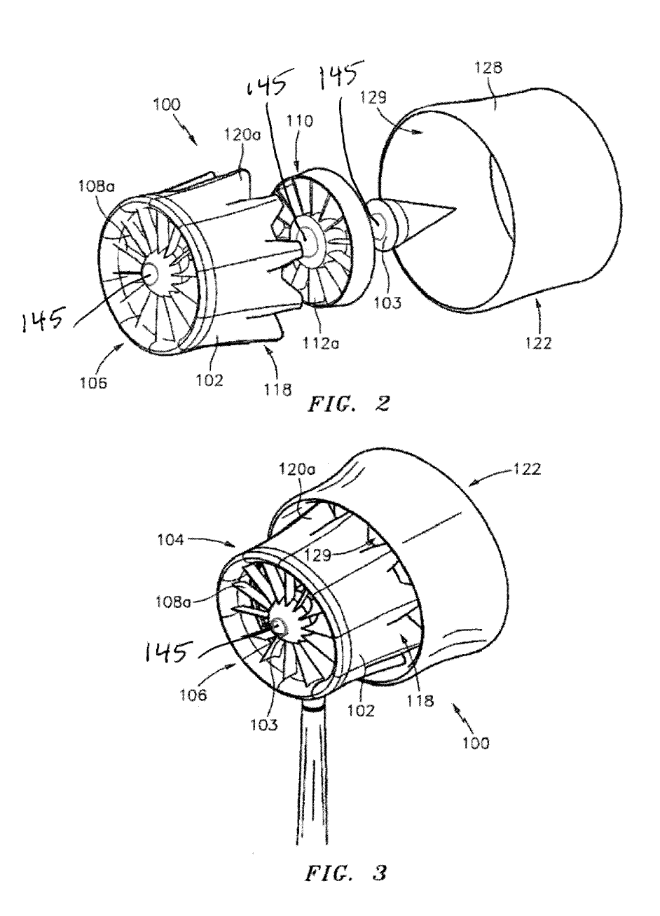

Referring to the drawings in detail, FIGS. 2-9B show alternate embodiments of Applicants' axial flow wind turbine with mixers and ejectors (“MEWT”).

In embodiments, the MEWT 100 is an axial flow turbine comprising:

(a) an aerodynamically contoured turbine shroud 102;

(b) an aerodynamically contoured center body 103 within and attached to the turbine shroud 102;

(c) a turbine stage 104, surrounding the center body 103, comprising a stator ring 106 of stator vanes (e.g., 108a) and an impeller or rotor 110 having impeller or rotor blades (e.g., 112a) downstream and “in-line” with the stator vanes (i.e., leading edges of the impeller blades are substantially aligned with trailing edges of the stator vanes), in which:
(i) the stator vanes (e.g., 108a) are mounted on the center body 103;
(ii) the impeller blades (e.g., 112a) are attached and held together by inner and outer rings or hoops mounted on the center body 103;

(d) a mixer 118 having a ring of mixer lobes (e.g., 120a) on a terminus region (i.e., end portion) of the turbine shroud 102, wherein the mixer lobes (e.g., 120a) extend downstream beyond the impeller blades (e.g., 112a); and

(e) an ejector 122 comprising a shroud 128, surrounding the ring of mixer lobes (e.g., 120a) on the turbine shroud, wherein the mixer lobes (e.g., 120a) extend downstream and into an inlet 129 of the ejector shroud 128.

Notably, the turbine 100 includes an open central passageway 145 along the central axis of the turbine 100. The central passageway 145 extends through the center body 103 and the impeller 110.

The center body 103 of the MEWT 100, as shown in FIG. 3, is preferably connected to the turbine shroud 102 through the stator ring 106 (or other means) to eliminate the damaging, annoying and long distance propagating low-frequency sound produced by traditional wind turbines as the turbine's blade wakes strike the support tower. The aerodynamic profiles of the turbine shroud 102 and ejector shroud 128 preferably are aerodynamically cambered to increase flow through the turbine rotor.

Applicants have calculated, for optimum efficiency in the preferred embodiments 100, the area ratio of the ejector pump 122, as defined by the ejector shroud 128 exit area over the turbine shroud 102 exit area will be between 1.5 and 3.0. The number of mixer lobes (e.g., 120a) would be between 6 and 14. Each lobe will have inner and outer trailing edge angles between 5 and 65 degrees. These angles are measured from a tangent line that is drawn at the exit of the mixing lobe down to a center line that is parallel to the axial center of the turbine. The primary lobe exit location will be at, or near, the entrance location or inlet 129 of the ejector shroud 128. The height-to-width ratio of the lobe channels will be between 0.5 and 4.5. The mixer penetration will be between 50% and 80%. The center body 103 plug trailing edge angles will be thirty degrees or less. The length to diameter (L/D) of the overall MEWT 100 will be between 0.5 and 1.25.

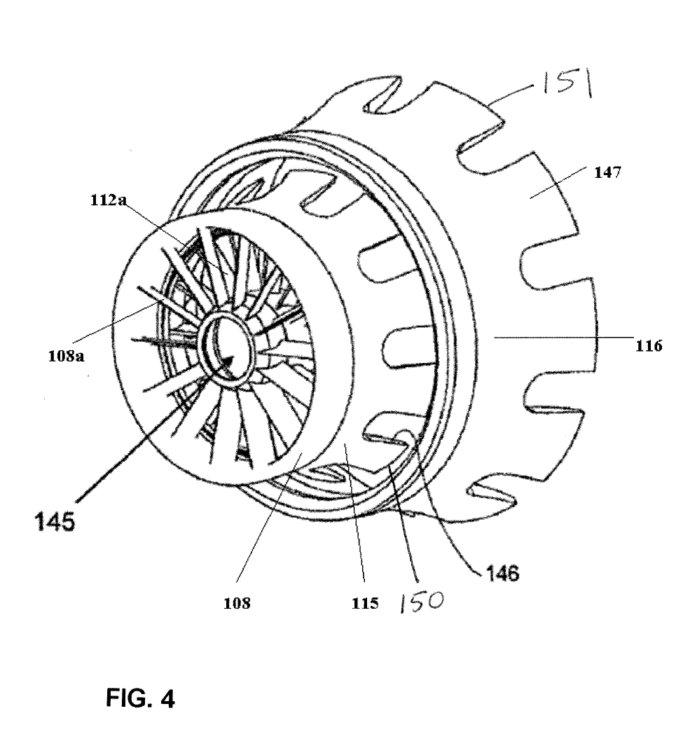

FIG. 4 is another embodiment of the wind turbine with the open central passageway 145. The turbine shroud 115 concentrically surrounds the impeller, of which the impeller blades 112a are visible. The turbine shroud 115 comprises mixing elements 146 on a downstream edge 150 thereof, or in other words the mixing elements are located around an outlet end or rear end of the turbine shroud. A stator assembly 108 resides in front of the impeller and comprises a plurality of stator vanes 108a. The turbine shroud 115 is in the shape of an airfoil with the suction side (i.e. low pressure side) on the interior of the shroud. An ejector shroud 116 is coaxial with the turbine shroud 115. The ejector shroud also comprises mixing elements 147 on a downstream edge 151 thereof, or in other words the mixing elements are located around an outlet end or rear end of the ejector shroud. Here, the mixing elements are depicted as slots.

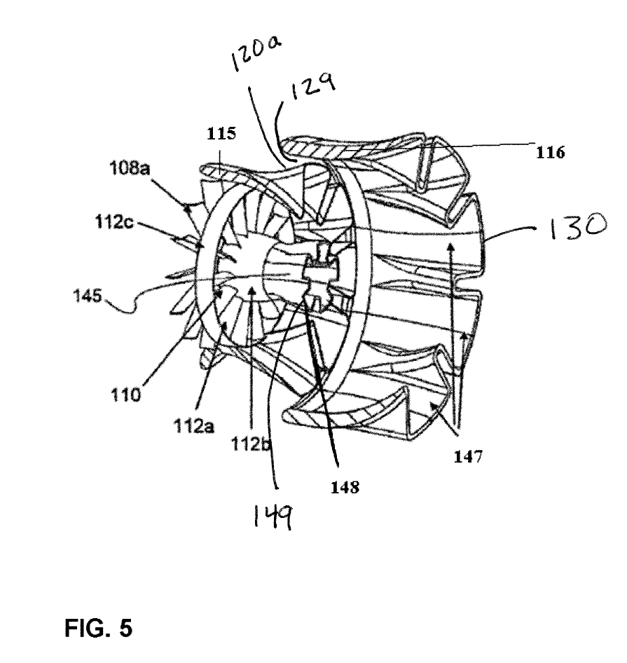

FIG. 5 shows a rear cross-sectional perspective view of another exemplary wind turbine. Stator vanes 108a are located in front of the impeller 112. The impeller 112 itself includes impeller blades 112a, a central ring 112b, and an outer impeller ring 112c. The center body 103 includes an open passageway 145. As shown here, the center body also comprises a plurality of mixing elements, shown here as mixer lobes 148, on a downstream edge 149 thereof, or in other words the mixing elements are located around an outlet end or rear end of the center body. The central ring 112b allows the impeller 112 to freely rotate about the center body 103. A turbine shroud 115 concentrically surrounds the impeller 112 and comprises turbine shroud mixing elements, shown here as mixer lobes 120a. An ejector shroud 116 coaxially surrounds the turbine shroud 115. The ejector shroud 116 also comprises a plurality of mixer lobes 130. The mixer lobes 120a of the turbine shroud 115 extend into the inlet 129 of the ejector shroud.

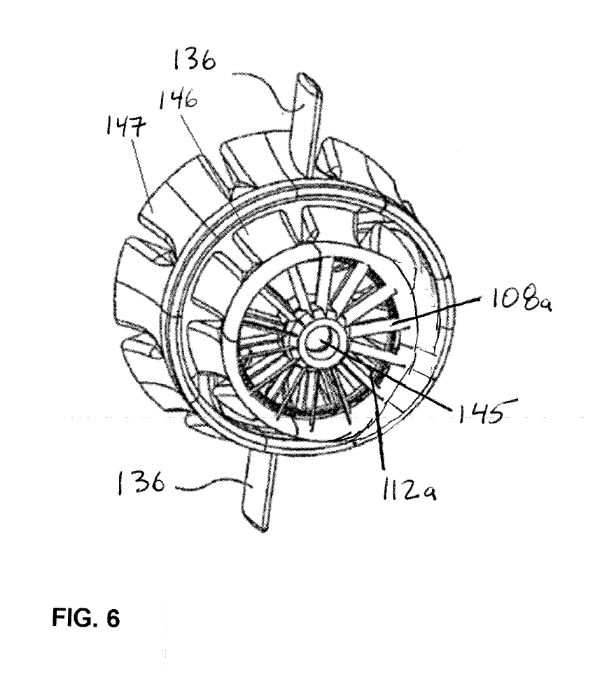

FIG. 6 shows an embodiment of a wind turbine having wing-tabs or directional vanes 136 to align the turbine with the direction of wind flow. The turbine here is shown with two wing-tabs; different numbers of wing-tabs are contemplated as well.

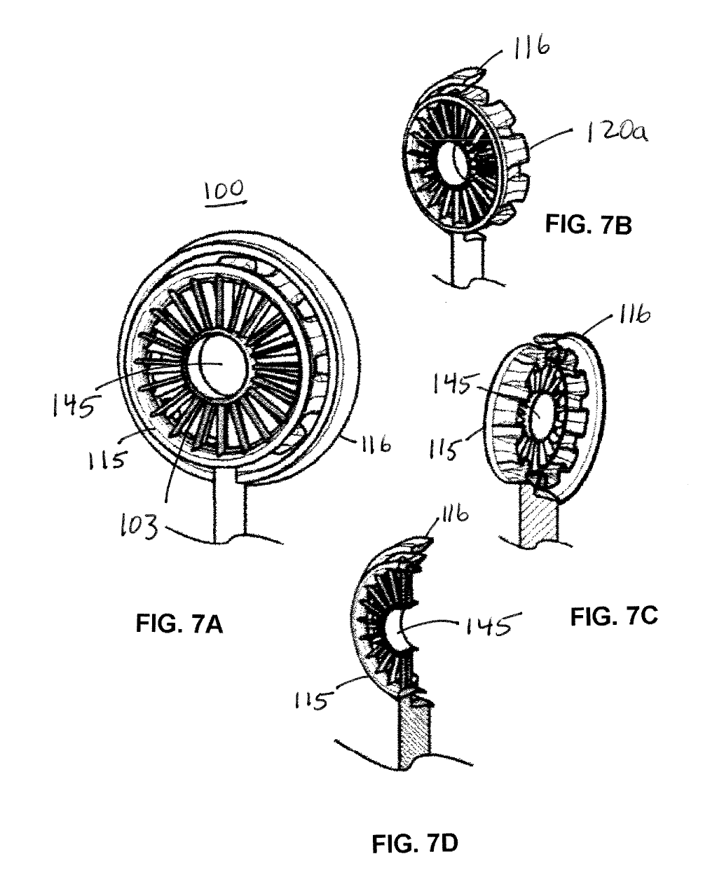

FIGS. 7A-7D show various views of another embodiment of a wind turbine. Here, the wind turbine 100 has a turbine shroud 115 and an ejector shroud 116. A central passageway 145 is present in the center body 103. Here, the turbine shroud 115 has mixer lobes 120a, while the ejector shroud 116 has a ring airfoil shape. Put another way, the ejector shroud 116 is cambered.

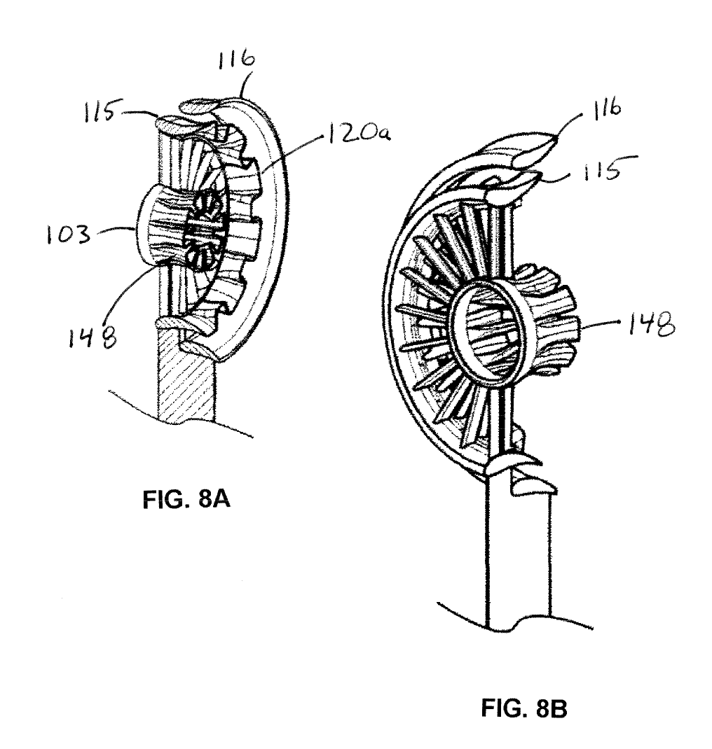

FIGS. 8A-8B show two views of another embodiment of a wind turbine. This turbine is similar to that shown in FIGS. 7A-7D. However, the central passageway also includes mixer lobes 148.

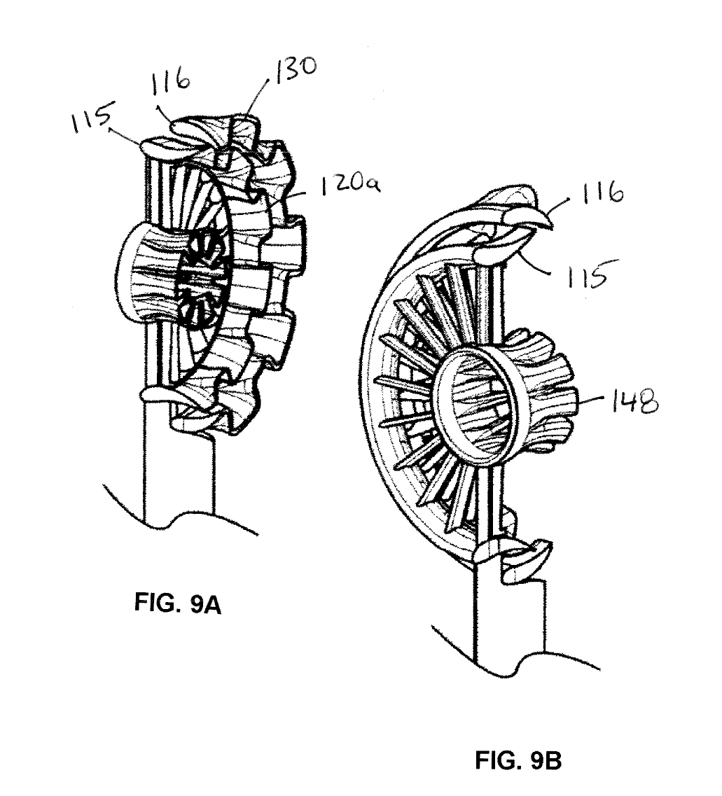

FIGS. 9A-9B show two views of another embodiment of a wind turbine. Here, the turbine shroud 115, ejector shroud 116, and central passageway 145 each have mixer lobes 120a, 130, 148 on their outlet end.

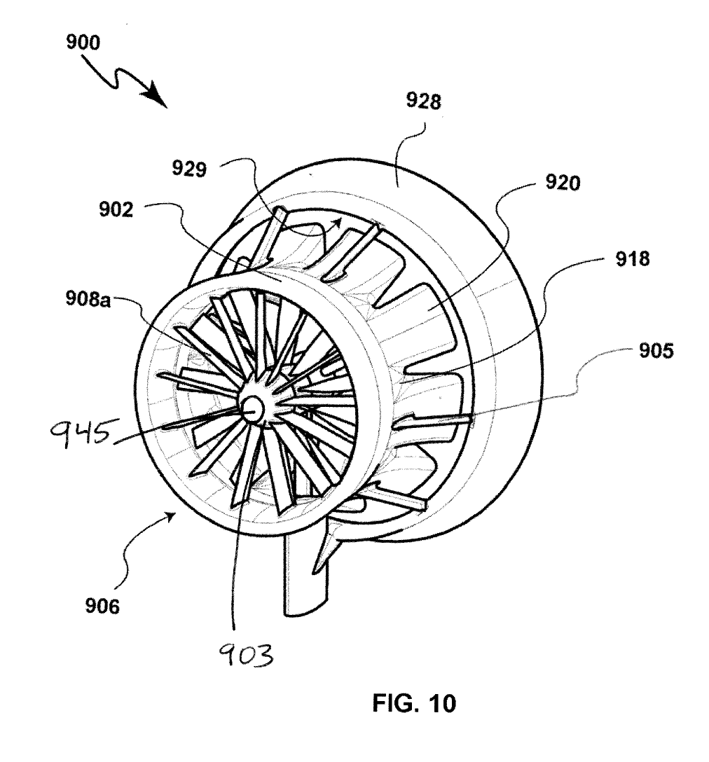

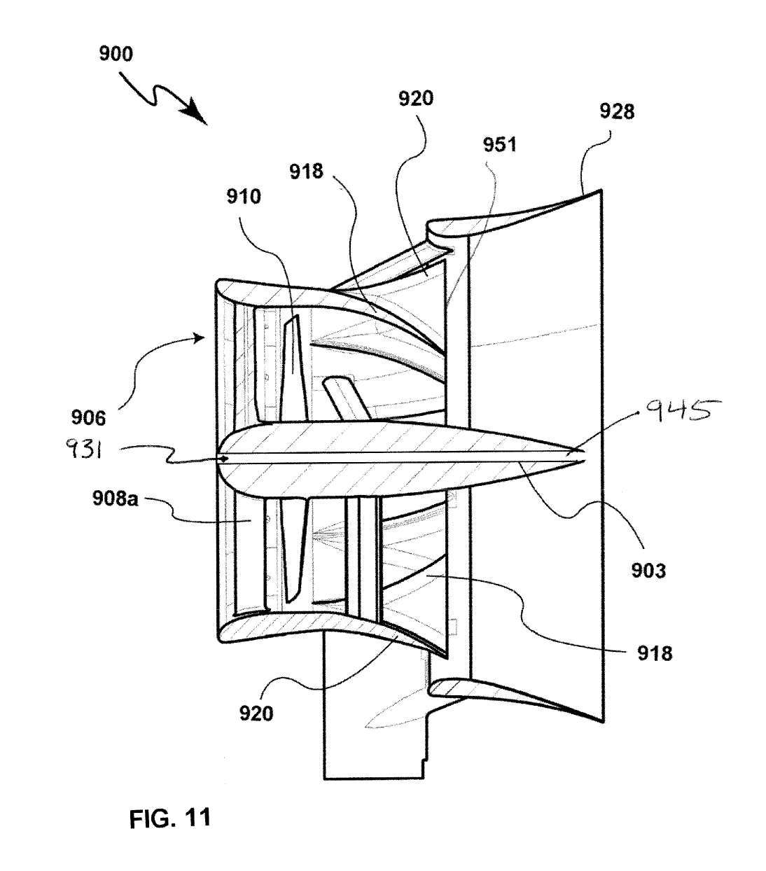

FIGS. 10-13 illustrate another embodiment of a MEWT. The MEWT 900 in FIG. 10 has a stator 908a and a rotor 910 configuration for power extraction. The turbine shroud 902 surrounds the rotor 910 and is supported by or connected to the blades of the stator 908a. The turbine shroud 902 is in the shape of an airfoil with the suction side (i.e. low pressure side) on the interior of the shroud. An ejector shroud 928 is coaxial with the turbine shroud 902 and is supported by connectors 905 extending between the two shrouds. An annular area is formed between the two shrouds. The rear end of the turbine shroud 902 is shaped to form two different sets of mixing lobes 918, 920. High energy mixing lobes 918 extend inward towards the central axis of the mixer shroud 902, which low energy mixing lobes 920 extend outwards away from the central axis. A central passageway 945 extends through the turbine 900. As seen in FIG. 11, there are no mixing elements on the downstream end of the nacelle or center body 903.

Free stream air 906 passing through the stator 908a has its energy extracted by the rotor 910. Relatively high energy air 929 (see FIG. 10) bypasses the stator 908a and is brought in behind the turbine shroud 902 by the high energy mixing lobes 918. Similarly, relatively high energy air 931 flows through the central passageway 945. The low energy mixing lobes 920 cause the relatively low energy air downstream from the rotor 910 to be mixed with the high energy air 929, 931. This mixing effect is discussed in greater detail below.

The nacelle 903 and the trailing edges of the low energy mixing lobes 920 and the trailing edge of the high energy mixing lobes 918 may be seen in FIG. 11. The ejector shroud 928 is used to draw in the high energy air 929.

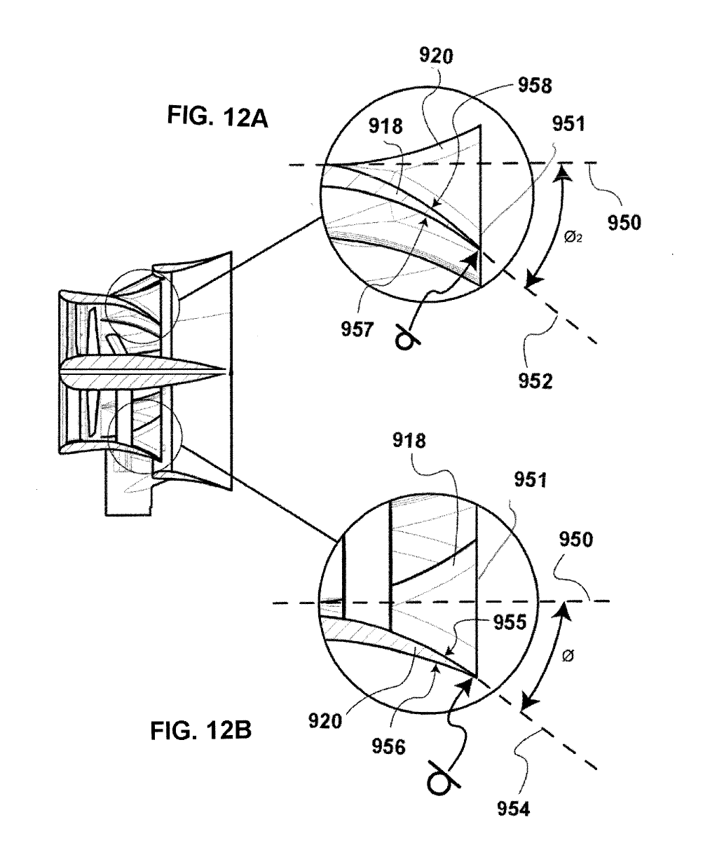

In FIG. 12A, a tangent line 952 is drawn along the interior trailing edge 957 of the high energy mixing lobe 918. A rear plane 951 of the turbine shroud 902 is present. A centerline 950 is formed tangent to the rear plane 951 that intersects the point where a low energy mixing lobe 920 and high energy mixing lobes 918 meet. An angle Ø₂ is formed by the intersection of tangent line 952 and centerline 950. This angle Ø₂ is between 5 and 65 degrees. Put another way, a high energy mixing lobe 918 forms an angle Ø₂ between 5 and 65 degrees relative to the turbine shroud 902.

In FIG. 12B, a tangent line 954 is drawn along the interior trailing edge 955 of the low energy mixing lobe 920. An angle Ø is formed by the intersection of tangent line 954 and centerline 950. This angle Ø is between 5 and 65 degrees. Put another way, a low energy mixing lobe 920 forms an angle Ø between 5 and 65 degrees relative to the turbine shroud 902.

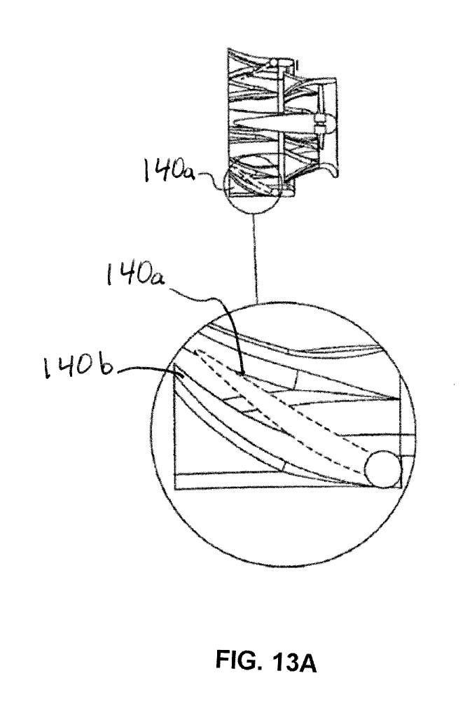

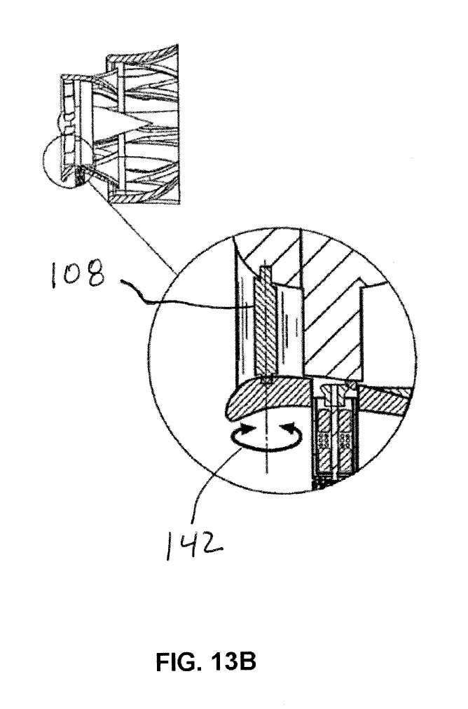

FIGS. 13A and 13B show two different mechanisms which may optionally be included controlling the flow of air into the wind turbine. FIG. 13A shows flow blockage doors 140a, 140b. The doors can be open (140b) or closed (140a) to reduce or stop flow through the turbine when damage to a generator or other components due to high wind speed is a possibility. In FIG. 13B, the exit angle of the stator vanes 108 can be mechanically varied in situ (i.e. the vanes can be pivoted, or are rotatable) (as indicated by reference numeral 142) to accommodate variations in the fluid stream velocity so as to assure minimum residual swirl in the flow exiting the rotor.

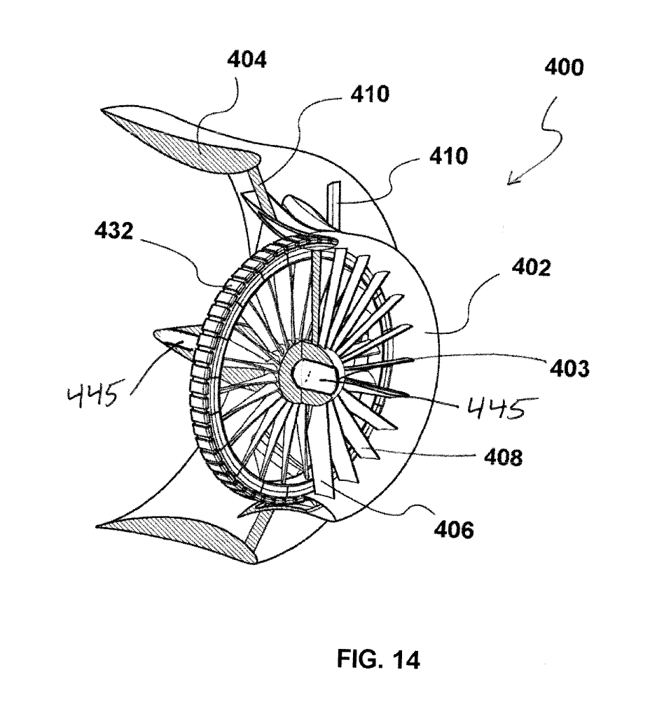

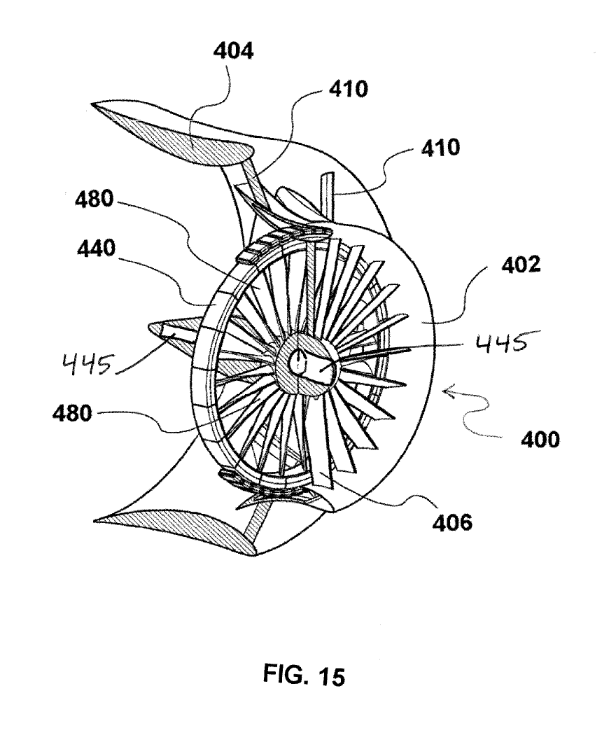

FIG. 14 and FIG. 15 show another exemplary embodiment of a wind turbine 400 of the present disclosure. The turbine 400 comprises a mixer shroud 402 and an ejector shroud 404. The mixer shroud 402 encloses a rotor/stator assembly 406. Stator vanes 408 run between the mixer shroud 402 and a nacelle or center body 403. A central passageway 445 runs through the center body 403 and the rotor/stator assembly 406. Attachment struts 410 join or connect the mixer shroud 402 with the ejector shroud 404.

The rotor/stator assembly 406 operates as a permanent ring generator. With reference to FIGS. 15-20, permanent magnets 440 are mounted on a rotor 420. One or more phase windings 432 are mounted in the stator 430. As the rotor rotates, a constant rotating magnetic field is produced by the magnets 440. This magnetic field induces an alternating current (AC) voltage in the phase windings 432 to produce electrical energy which can be captured. One advantage of the permanent ring generator compared to an induction generator is that the induction generator requires power from the electrical grid itself to form a magnetic field. In contrast, the permanent magnet generator does not need power from the grid to produce electricity.

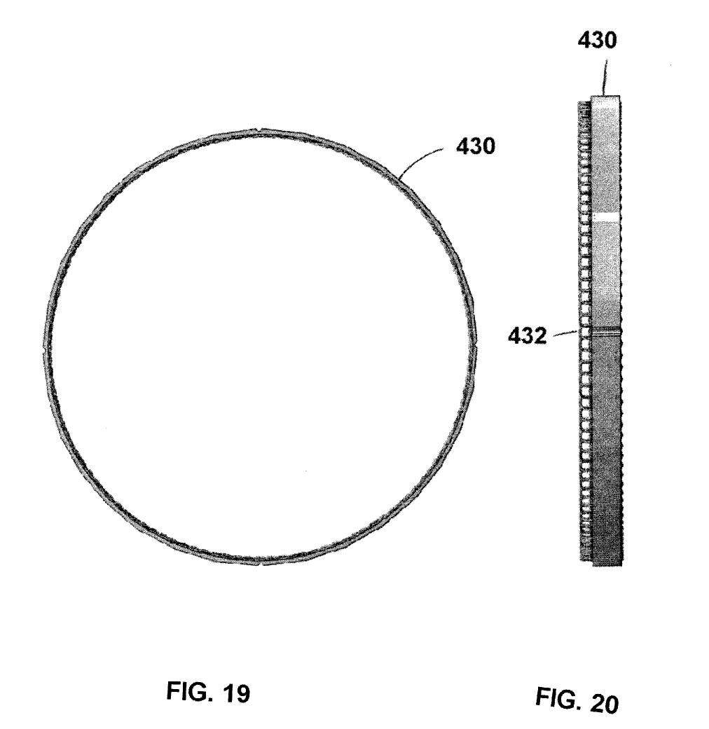

Each phase winding is comprised of a series of coils. In particular embodiments, the stator has three phase windings connected in series for producing three-phase electric power. Each winding contains 40 wound coils in series spaced by nine degrees, so that the combination of three phase windings covers the 360° circumference of the stator. FIG. 19 and FIG. 20 show the assembled stator 430 from the front and side, respectively.

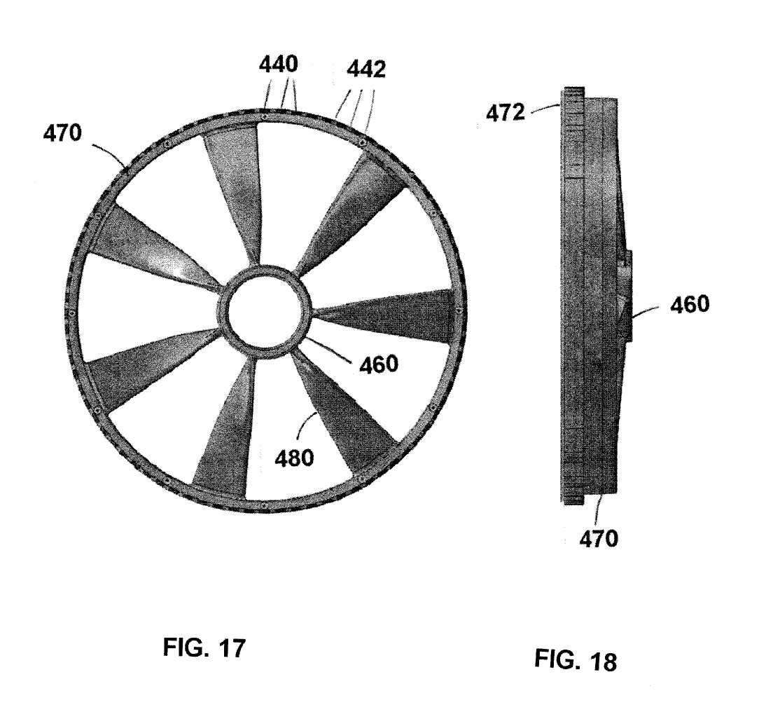

FIG. 15 is cut away to show the permanent magnets 440. Referring now to FIG. 17 and FIG. 18, the rotor 450 contains a central ring 460 and an outer ring 470. Rotor blades 480 extend between the central ring 460 and the outer ring 470, connecting them together. Referring back to FIG. 14, the center body 403 extends through the central ring 460 to support the rotor 450 and fix its location relative to the mixer shroud 402.

A plurality of permanent magnets 440 is located on the outer ring 470. The magnets are generally evenly distributed around the circumference of the rotor and along the outer ring 470. As seen in FIG. 18, in embodiments the magnets are located along a rear end 472 of the outer ring. In particular embodiments, there are 80 permanent magnets spaced every 4.5 degrees. The magnet poles are oriented radially on the outer ring, i.e. one pole being closer to the central ring than the other pole. The magnets are arranged so that their poles alternate, for example so that a magnet with its north pole oriented outward is surrounded by two poles with their south pole oriented outward. The magnets 440 are separated by potting material 442 which secures the magnets to the rotor 450.

In embodiments, the permanent magnets are rare earth magnets, i.e. are made from alloys of rare earth elements. Rare earth magnets produce very high magnetic fields. In embodiments, the permanent magnets are neodymium magnets, such as Nd₂Fe₁₄B.

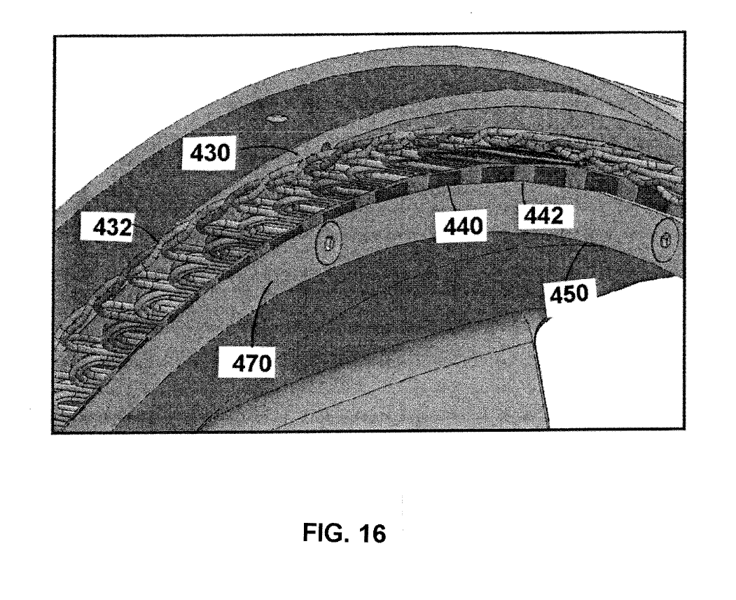

FIG. 16 is an enlarged view showing the rotor 450 and stator 430 and their relationship to each other.

One advantage of a mixer-ejector wind turbine as described herein compared to traditional three-bladed horizontal axis wind turbines is that the blades of a typical turbine may be as much as 50 meters long or longer. This results in a large swept area for the blades. However, the area enclosed by the permanent magnets is much smaller. Because the ratio of the area for the blades to the area for the magnets is very high, the ring generator is unable to turn as efficiently as it otherwise could. However, the ratio of the area for the MEWT is about 1:1, which allows for greater efficiency and greater power generation. Another advantage is that the MEWT has a lower “cut-in” speed, i.e. the rotor on the MEWT will start turning and generating energy at lower wind speeds. Normally, due to the intermittent generation of the wind turbine, the turbine is not directly connected to an electrical grid because the fluctuations in electricity production would inject voltage and frequency disturbances into the grid.

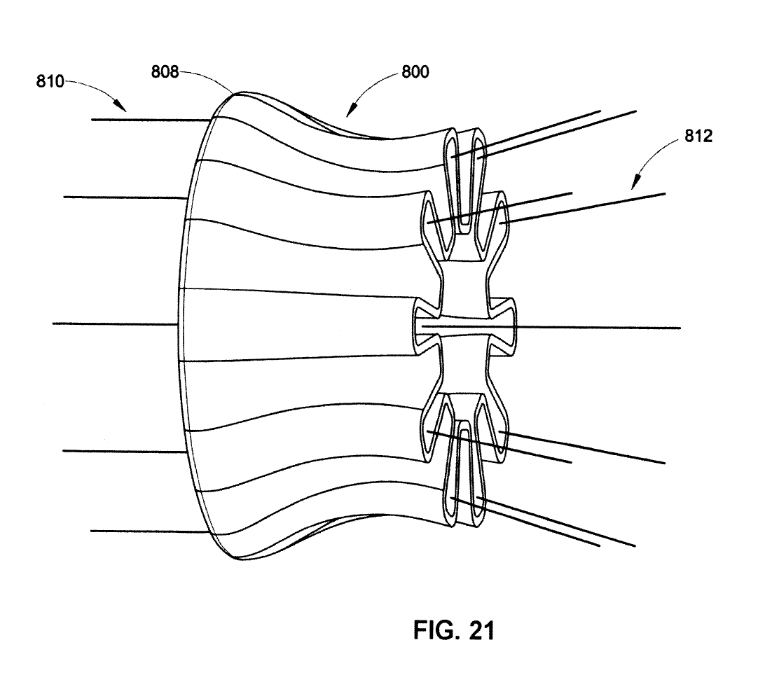

FIGS. 21-25 illustrate methods by which energy or power is produced, or by which the energy or power of a fluid turbine is increased, or by which additional amounts of energy are extracted from a fluid stream.

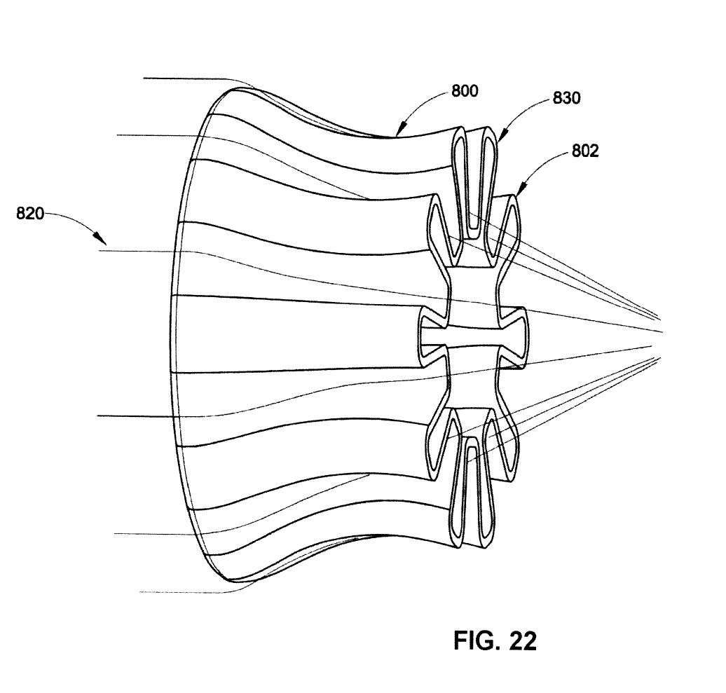

As shown in FIGS. 21 and 22, a center body 800 has an outlet or exit end 802. A plurality of mixer lobes 830 is disposed around this outlet 802. Only the rear portion of the center body is shown, and the impellers upstream of the center body are not shown. A first fluid stream 810 passes through the central passageway 845, while a second fluid stream 820 that passes outside the center body has flowed through an impeller, resulting in the extraction of energy or power from the second fluid stream, so that the second fluid stream is a relatively slower stream compared to the first fluid stream. Reference numeral 812 refers to the first fluid stream as it exits the outlet 802 of the center body 800.

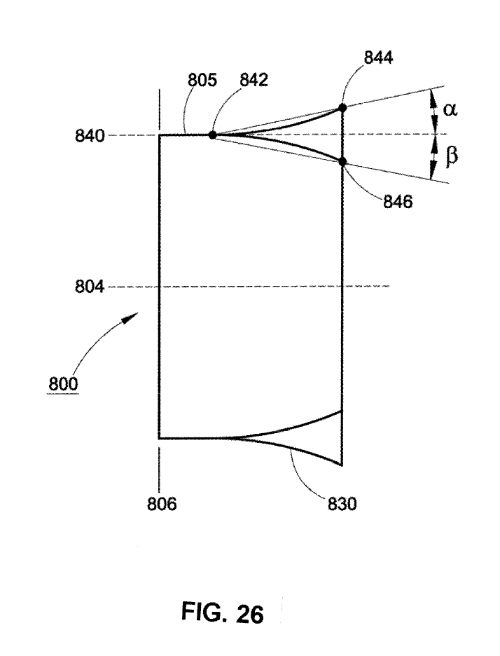

Referring to the cross-sectional view of FIG. 26, each mixer lobe 830 has an outer trailing edge angle α and an inner trailing edge angle β. The center body 800 has a central axis 804. The angles α and β are measured relative to a plane 840 which is parallel to the central axis, perpendicular to the entrance plane 806 of the center body, and along the surface 805 of the center body. The angle is measured from the vertex point 842 at which the center body begins to diverge to form the mixer lobes. The outer trailing edge angle α is measured at the outermost point 844 on the trailing edge of the mixer lobe, while the inner trailing edge angle β is measured at the innermost point 846 on the trailing edge of the mixer lobe. In some embodiments, outer trailing edge angle α and inner trailing edge angle β are different, and in others α and β are equal. In particular embodiments, inner trailing edge angle β is greater than or less than outer trailing edge angle α. As mentioned previously, each angle can be independently in the range of 5 to 65 degrees.

As seen in FIG. 21, the mixer lobes 830 cause first fluid stream 812 to flare outwards after passing through the turbine. Put another way, the center body 800 directs relatively high energy fluid stream 812 away from central axis 804.

As seen in FIG. 22, the mixer lobes 830 cause second fluid stream 820 to flow inwards. Put another way, the center body 800 directs relatively low energy fluid stream 820 toward central axis 804.

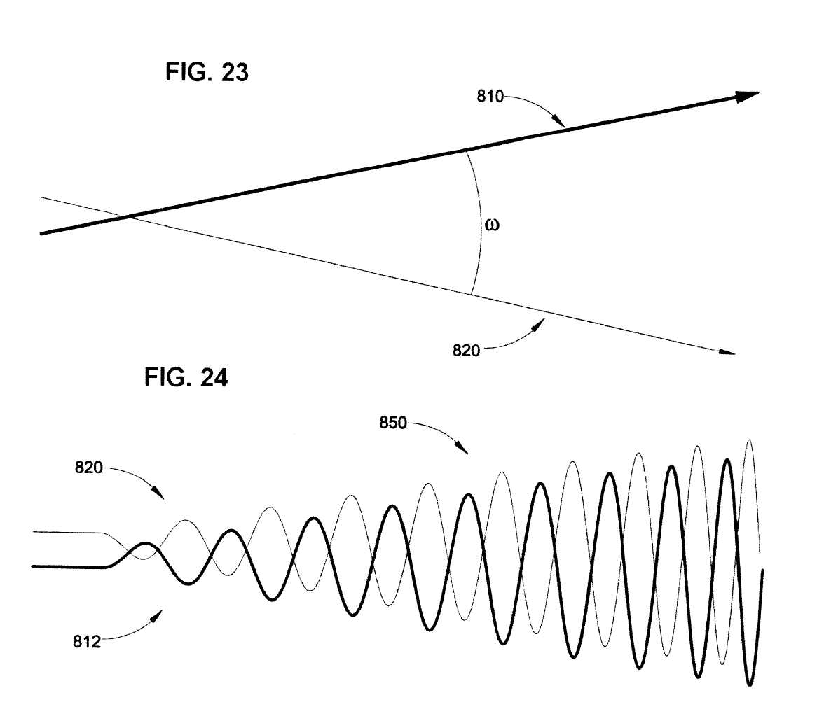

As noted in FIG. 23, first fluid stream 812 and second fluid stream 820 thus meet at an angle ω. Angle ω is typically between 10 and 50 degrees. This design of the mixer shroud takes advantage of axial vorticity to mix the two fluid streams.

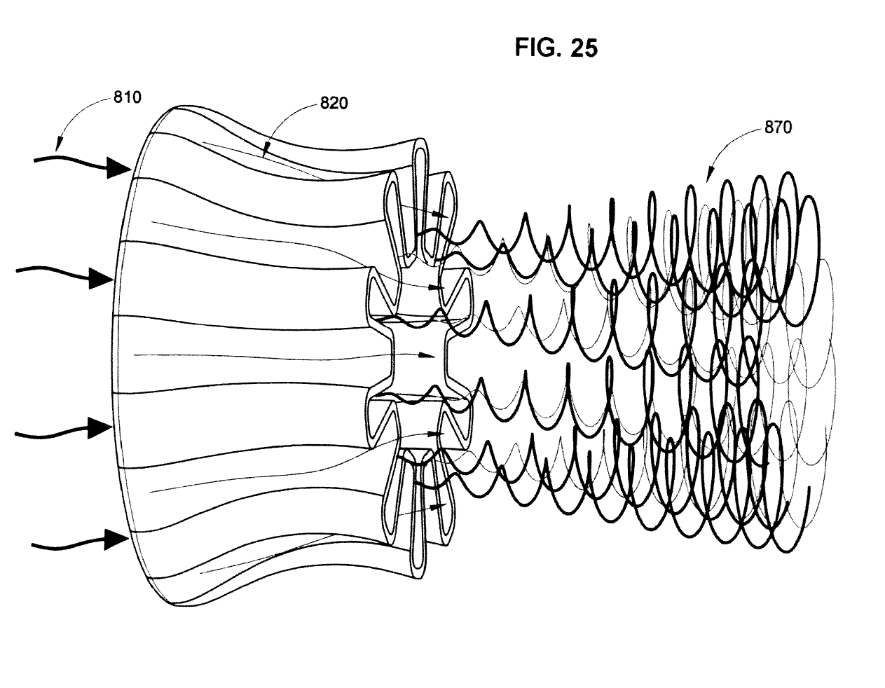

As shown in FIGS. 24 and 25, the meeting of the two fluid streams 812, 820 causes an “active” mixing of the two fluid streams. This differs from “passive” mixing which would generally occur only along the boundaries of two parallel fluid streams. In contrast, the active mixing here results in substantially greater energy transfer between the two fluid streams.

FIG. 24 illustrates a vortex 850 formed by the meeting of relatively high energy fluid stream 812 and relatively low energy fluid stream 820 behind one mixer lobe. FIG. 25 shows the series of vortices formed by the plurality of mixer lobes 830 at the outlet 802 of the center body. The vortices are formed behind the center body 800. Another advantage of this design is that the series of vortices formed by the active mixing reduce the distance downstream of the turbine in which turbulence occurs. With conventional turbines, the resulting downstream turbulence usually means that a downstream turbine must be placed a distance of 10 times the diameter of the upstream turbine away in order to reduce fatigue failure. In contrast, the present turbines can be placed much closer together, allowing the capture of additional energy from the fluid.

Alternatively, the center body 800 can be considered as separating incoming air into a first fast fluid stream 810 and a second fast fluid stream 820. The first fast fluid stream passes through the central passageway. The second fast fluid stream passes through the impeller and energy is extracted therefrom, resulting in a slow fluid stream 820 flowing along the exterior of the center body, which is relatively slower than the first fast fluid stream. The slow fluid stream 820 is then mixed with the first fast fluid stream 812.

The wind turbine of the present disclosure, including the hollow center body, provides unique benefits over existing systems. The wind turbine provides a more effective and efficient wind generating system and significantly increases the maximum power extraction potential. The wind turbine is quieter, cheaper, and more durable. The wind power system operates more effectively in low wind speeds and is more acceptable aesthetically for both urban and suburban settings. The wind turbine reduces bird strikes, the need for expensive internal gearing, and the need for turbine replacements caused by high winds and wind gusts. The design is more compact and structurally robust. The turbine is less sensitive to inlet flow blockage and/or alignment of the turbine axis with the wind direction and uses advanced aerodynamics to automatically align itself with the wind direction. Mixing of high energy air and low energy air inside the turbine is more efficient which reduces turbulence.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A wind turbine comprising:
a center body comprising a central passageway;
an impeller disposed about the center body and comprising a plurality of impeller blades; and
a turbine shroud disposed about the impeller.

2. The wind turbine of claim 1, wherein the turbine shroud is in the shape of a ring airfoil.

3. The wind turbine of claim 1, wherein the turbine shroud has a plurality of mixer lobes disposed around an exhaust end.

4. The wind turbine of claim 3, wherein each mixer lobe on the turbine shroud has an inner trailing edge angle and an outer trailing edge angle, and the inner angle and the outer angle are independently in the range of 5 to 65 degrees.

5. The wind turbine of claim 1, wherein the center body further comprises a plurality of mixer lobes disposed around an outlet end.

6. The wind turbine of claim 5, wherein each mixer lobe on the center body has an inner trailing edge angle and an outer trailing edge angle, and the inner angle and the outer angle are independently in the range of 5 to 65 degrees.

7. The wind turbine of claim 1, further comprising an ejector shroud downstream from and coaxial with the mixer shroud, wherein a mixer shroud outlet extends into an ejector shroud inlet.

8. The wind turbine of claim 7, wherein the ejector shroud is in the shape of a ring airfoil.

9. The turbine of claim 7, wherein the ejector shroud has a ring of mixer lobes around an ejector shroud outlet.

10. The wind turbine of claim 9, wherein each mixer lobe on the ejector shroud has an inner trailing edge angle and an outer trailing edge angle, and the inner angle and the outer angle are independently in the range of 5 to 65 degrees.

11. The wind turbine of claim 1, wherein the impeller is a rotor/stator assembly, the rotor/stator assembly including a rotor and a stator;
wherein the stator has at least one phase winding; and
wherein the rotor has a central ring, an outer ring, a plurality of rotor blades extending between the central ring and the outer ring, and a plurality of permanent magnets on the outer ring.

12. The wind turbine of claim 11, wherein the plurality of permanent magnets are located along a rear end of the outer ring.

13. The wind turbine of claim 1, further comprising a wing-tab for aligning the wind turbine with the direction of airflow.

14. The wind turbine of claim 1, wherein the turbine shroud has a non-circular frontal cross-section.

15. The wind turbine of claim 1, wherein an inlet area of the turbine shroud is greater than an exit area of the turbine shroud.

16. The wind turbine of claim 1, further comprising a power generator located in the center body and connected to the impeller.

17. A wind turbine comprising:
a center body comprising a central passageway;
a rotor assembly which rotates around the center body;
a turbine shroud surrounding the rotor assembly; and
a stator assembly upstream of the rotor assembly and connecting the turbine shroud with the center body;
wherein the central passageway comprises a plurality of mixer lobes disposed around an outlet end thereof.

18. The wind turbine of claim 17, wherein the turbine shroud has a plurality of mixer lobes disposed around an exhaust end, wherein each mixer lobe on the turbine shroud has an inner trailing edge angle and an outer trailing edge angle, and the inner angle and the outer angle are independently in the range of 5 to 65 degrees.

19. The wind turbine of claim 17, further comprising an ejector shroud downstream from and coaxial with the mixer shroud, wherein a mixer shroud outlet extends into an ejector shroud inlet.

20. The wind turbine of claim 19, wherein the ejector shroud has a ring of mixer lobes around an ejector shroud outlet, wherein each mixer lobe on the ejector shroud has an inner trailing edge angle and an outer trailing edge angle, and the inner angle and the outer angle are independently in the range of 5 to 65 degrees.

21. The wind turbine of claim 17, wherein the stator has at least one phase winding; and
wherein the rotor has a central ring, an outer ring, a plurality of rotor blades extending between the central ring and the outer ring, and a plurality of permanent magnets on the outer ring.
